(19) United States
(12) Patent Application Publication
(10) Pub. No.: US 2014/0161104 A1
(43) Pub. Date: Jun. 12, 2014

(54) DYNAMIC HYSTERESIS SELECTION

(71) Applicant: QUALCOMM INCORPORATED, San Diego, CA (US)

(72) Inventors: Tom Chin, San Diego, CA (US); Wei-Jei Song, San Diego, CA (US)

(73) Assignee: QUALCOMM Incorporated, San Diego, CA (US)

(21) Appl. No.: 13/755,336

(22) Filed: Jan. 31, 2013

Related U.S. Application Data
(60) Provisional application No. 61/735,404, filed on Dec. 10, 2012.

(51) Int. Cl. H04W 72/04

(52) U.S. Cl. CPC H04W 72/0473; H04W 72/0446
USPC 370/336; 370/329

(57) ABSTRACT

A method of wireless communication includes determining an operating parameter of a mobile device. The method also includes dynamically setting a hysteresis for a gain state of a power amplifier (PA) based at least in part on the determined operating parameter. The hysteresis may include a power level hysteresis and a temporal hysteresis

### CROSS-REFERENCE TO RELATED APPLICATION

This application claims the benefit under 35 U.S.C. §119(e) to U.S. Provisional Patent Application No. 61/735,404 entitled “DYNAMIC HYSTERESIS SELECTION,” filed on Dec. 10, 2012, the disclosure of which is expressly incorporated by reference herein in its entirety.

### BACKGROUND

1. Field

Aspects of the present disclosure relate generally to wireless communication systems, and more particularly, to dynamically selecting a hysteresis mode in a TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to an aspect of the present disclosure, method of wireless communication is presented. The method includes determining an operating parameter of a mobile device. The method also includes dynamically setting a hysteresis for a gain state of a power amplifier (PA) based at least in part on the determined operating parameter.

According to another aspect of the present disclosure, an apparatus for wireless communications is presented. The apparatus includes means for determining an operating parameter of a mobile device. The apparatus also includes means for dynamically setting a hysteresis for a gain state of a power amplifier (PA) based at least in part on the determined operating parameter.

According to yet another aspect of the present disclosure, a computer program product for wireless communications is presented. The computer program product includes a non-transitory computer-readable medium having program code recorded thereon. The program code includes program code to determine an operating parameter of a mobile device. The program code also includes program code to dynamically setting a hysteresis for a gain state of a power amplifier (PA) based at least in part on the determined operating parameter.

According to still yet another aspect of the present disclosure, an apparatus for wireless communications is presented. The apparatus includes a memory. The apparatus also includes a processor(s) coupled to the memory. The processor is configured to determine an operating parameter of a mobile device. The processor is also configured to dynamically setting a hysteresis for a gain state of a power amplifier (PA) based at least in part on the determined operating parameter.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a block diagram conceptually illustrating an example of gain states.

FIG. 5 is a block diagram conceptually illustrating a finite state machine based on an aspect of the present disclosure.

FIG. 6 is a block diagram conceptually illustrating an example of gain states.

FIG. 7 is a block diagram illustrating a method for dynamically selecting a hysteresis mode according to one aspect of the present disclosure.

FIG. 8 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

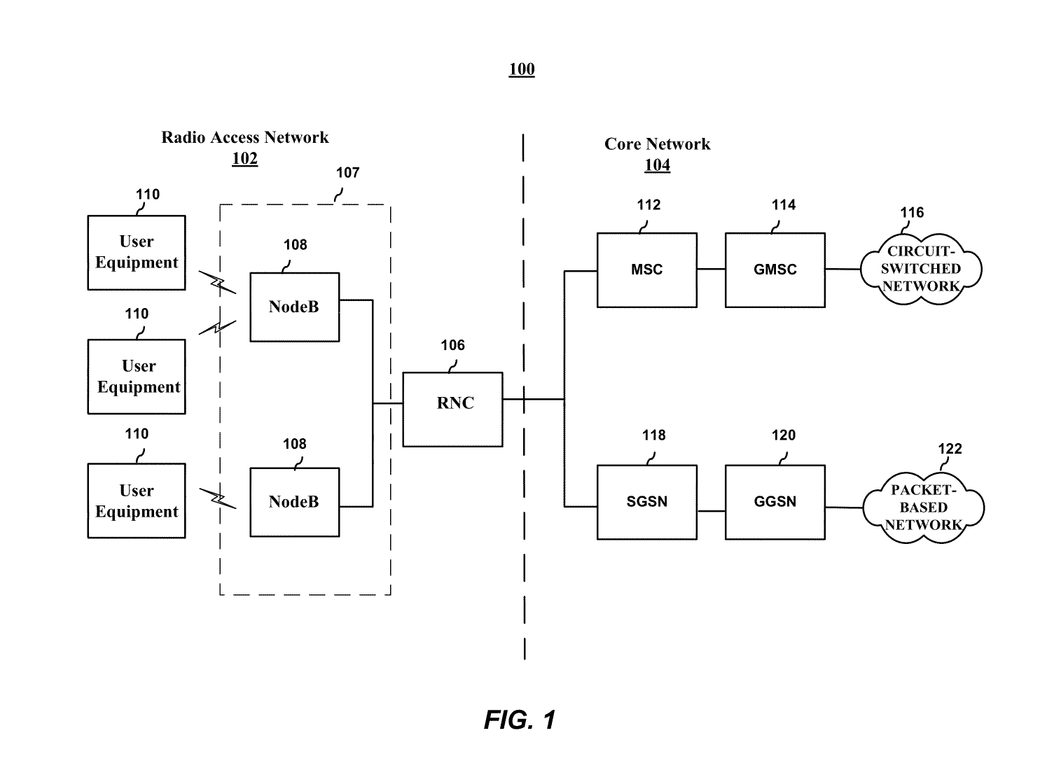

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

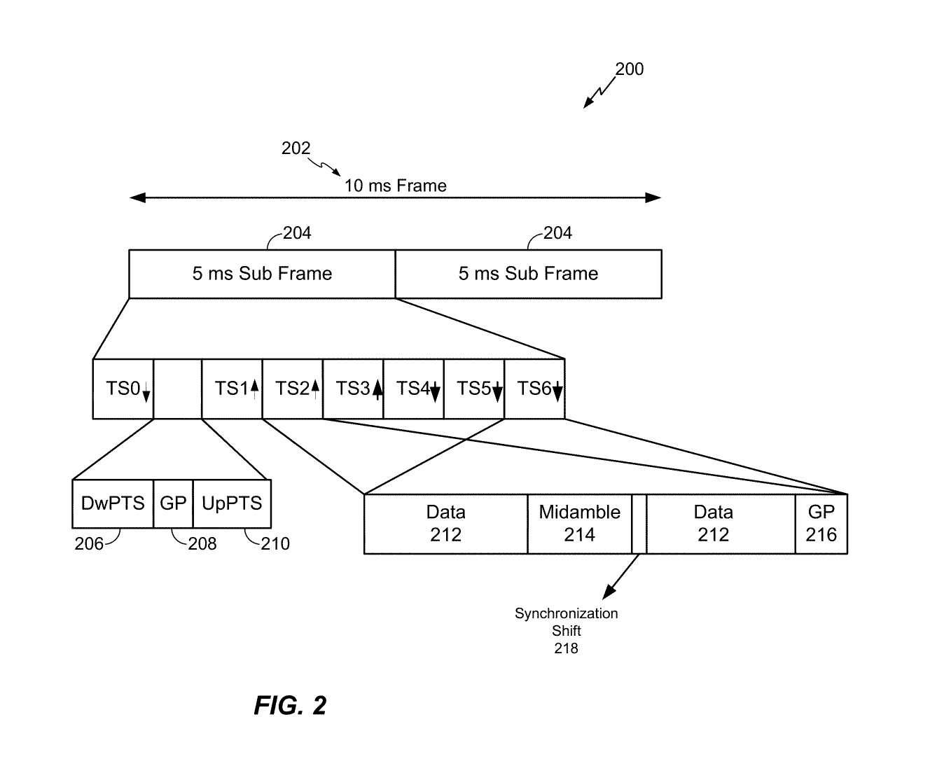

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. SS bits 218 only appear in the second part of the data portion. The SS bits 218 immediately following the midamble can indicate three cases: decrease shift, increase shift, or do nothing in the upload transmit timing. The positions of the SS bits 218 are not generally used during uplink communications.

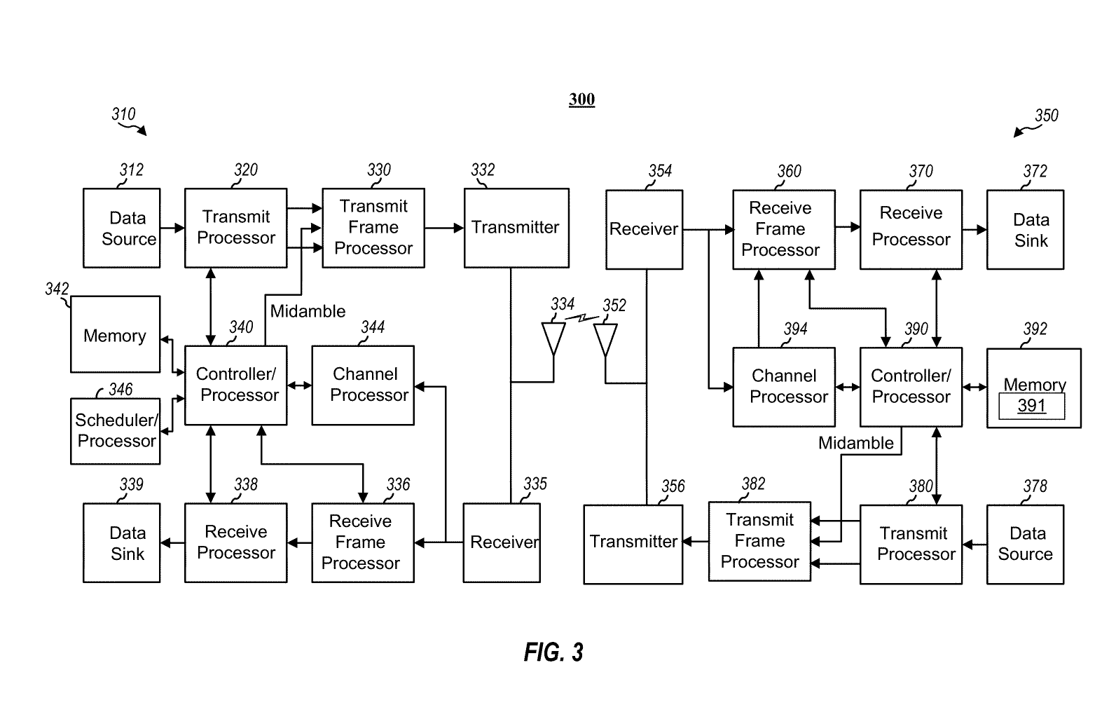

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a hysteresis module 391 which, when executed by the controller/processor 390, configures the UE 350 for switching between power level hysteresis and temporal hysteresis. A scheduler/processor 346 at the node B 310 may be used to allocate resources to the UEs and schedule downlink and/or uplink transmissions for the UEs.

### Dynamic Time and Power Level Hysteresis

In a conventional system, the power amplification (e.g., power consumption) of a mobile device is specified at the time of manufacturing for either performance or power consumption. That is, the mobile device may be pre-configured or hard coded for power level hysteresis or temporal hysteresis (e.g., time hysteresis). To improve performance and/or power consumption of a user equipment (UE), one aspect of the present is directed to a switching mechanism for the UE to switch between power level hysteresis and temporal hysteresis.

In most conventional systems, the gain state range for the power amplification may be between −55 dbm to 22 dbm. A low gain state may be specified for low power use/consumption and a high gain state may be specified for higher performance/data rate. The power level hysteresis is specified to adjust the gain state to improve transmit quality and the temporal hysteresis is specified to adjust the gain state to improve power usage/consumption. Specifically, power level hysteresis sets the transmission automatic gain control to a higher gain state to provide an improved transmit signal quality (e.g., high signal to noise ratio (SNR) for increased data rate). Additionally, the temporal hysteresis sets the transmission automatic gain control to a lower gain states that has a lower signal to noise ratio to improve the transmit power.

In contrast, conventional systems only specify one hysteresis mode (e.g., power level hysteresis or temporal hysteresis) regardless of whether the mobile device is in a voice or data mode. Aspects of the present disclosure provide for a switching mechanism to switch between power level hysteresis and temporal hysteresis based on a slot configuration, voice traffic, channel quality indicator (CQI), HSPA state, transmission mode, channel assignment, link quality, dropped packets, or a combination thereof. Specifically, prior to, or during, data or voice communication, the UE may determine the type of communication and select the appropriate hysteresis mode.

For example, power level hysteresis may be desirable for high-speed uplink packet access. That is, the UE may desire to transmit at a high signal to noise ratio for an increased data rate/throughput, and therefore, the power level hysteresis is desirable. If the UE selects a gain state that does not match the desired performance level, the UE may have to re-transmit the data, which may result in an undesirable power consumption. Furthermore, temporal hysteresis may be desirable for a low number of time slot assignments (e.g., voice traffic) That is, voice traffic is communicated at a low gain state, and therefore, a high gain state may consume more power than is necessary for voice traffic.

Because the downlink (DL) and uplink (UL) paths for a network, such as TD-SCDMA, are substantially symmetric, the uplink channel quality can be derived from the downlink quality metric. In one configuration, temporal hysteresis may be used when the uplink quality is above a threshold and power level hysteresis may be used when uplink quality is equal to or less than a threshold and a specific number of re-transmissions are observed.

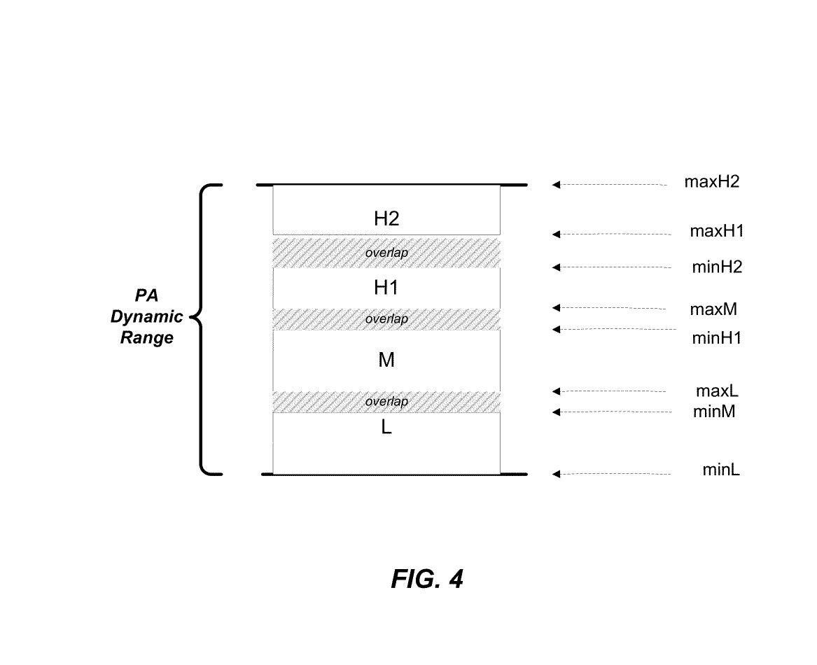

FIG. 4 illustrates an example of the range of gain states. As shown in FIG. 4 the power consumption may include four gain states low (L), medium (M), first high (H1), and second high (H2). An overlap exists between each gain state. That is an overlap exists between the minimum for the medium gain state (minM) and the maximum of the lower gain state (maxL). Another overlap exists between the minimum for the first high gain state (minH1) and the maximum of the medium gain state (maxM). Finally, another overlap exists between the minimum for the second high gain state (minH2) and the maximum of the first high gain state (maxH1). The low bound of the gain state range may be the minimum of the low gain state (minL) and the high bound of the gain state range may be the maximum of the second high gain state (maxH2). It should be noted that FIG. 4 is not drawn to scale and is a non-limiting example of the range of gain states.

In one configuration, when the power consumption is in an overlap region, the UE determines whether to move to a higher or lower gain state based on the selected hysteresis (e.g., power level hysteresis or temporal hysteresis).

In the present configuration, when the UE determines to use temporal hysteresis, a timer is activated for the active gain state when the output power is in an overlap region. The timer is not activated when the output power is in a non-overlap region. The output power may be referred to as a power level.

For the temporal hysteresis, it is desirable to keep the gain state in a lower gain state. In one configuration, two conditions may trigger the gain state to drop to the next immediate lower gain state. Specifically, when the timer expires (e.g., timeout) for the current gain state, the gain state drops to the next immediate lower gain state. Furthermore, the gain state may drop to the next immediate lower gain state when the power consumption drops below the current lower boundary and into the immediate lower region which is not overlapped by the current power region.

The stepping down of a gain state is desirable for lower power consumption. In the present configuration, the timer is reset when the power is not in an overlap region. Furthermore, when the gain state is transitioned out of the current gain state, to a higher or lower gain state, the timer associated with the new gain state is reset and the timer starts if the new power level is in the new overlap region of the new gain state.

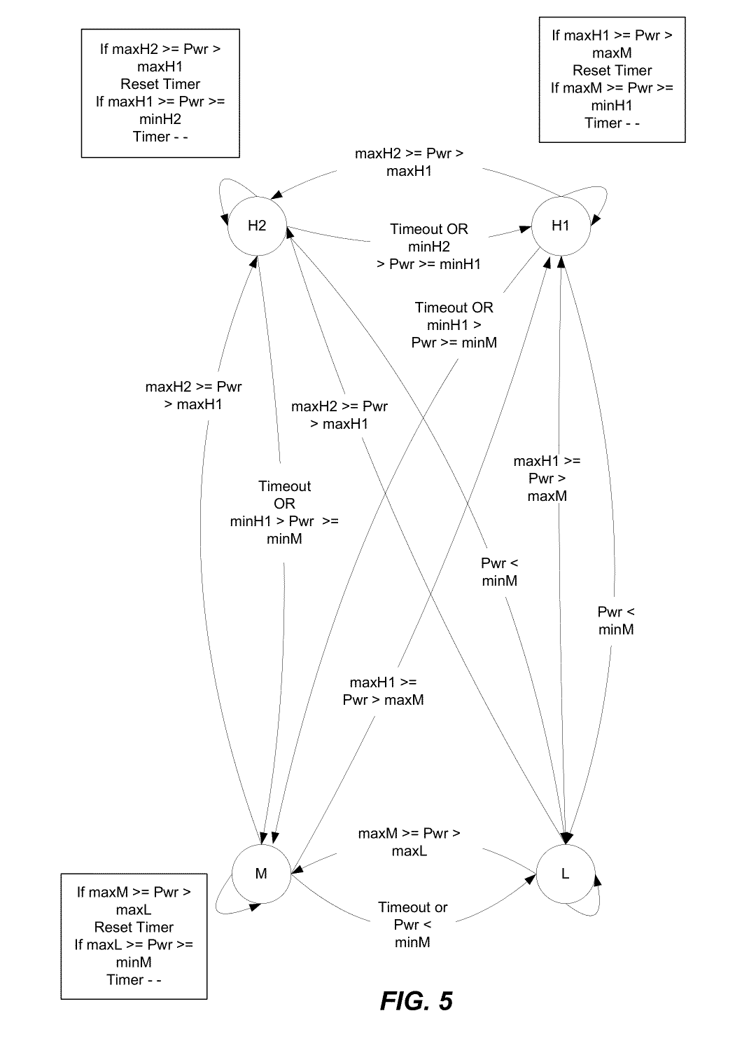

FIG. 5 illustrates a finite state machine for temporal hysteresis based on an aspect of the present disclosure. As shown in FIG. 5, the gain state may move to a higher or lower gain state if the power consumption is greater than or less than the power consumption of the current gain state. Furthermore, as shown in FIG. 5, a timer is reset with a predetermined value and the timer begins counting down when the power level reaches the overlap area of the gain state (N) and its lower gain state neighbor. The expiration of the timer will move the gain state to the lower gain state (N−1). Additionally, the timer will begin counting down when in the lower overlap of a current gain state. Finally, as shown in FIG. 5, the gain state may also transition to a lower gain state upon expiration of the timer (e.g., timeout). The timer is initiated when the power consumption is in an overlap between two gain states (see FIG. 4).

That is, the timer is specified to determine the amount of time in one of the overlap regions. In one configuration, because the power may only be in one overlap region, one timer may be specified for all three overlap regions. For example, as shown in FIG. 5, when the power level is in the overlap region for H1 (e.g., maxM is greater than or equal to the power level and minH1 is less than or equal to the power level), then the timer begins to count down to determine the time in the overlap region. Upon expiration of the timer, the gain state may move to the lower gain state (e.g., M).

As previously discussed, in one configuration, when the power consumption is in an overlap region, the UE determines whether to move to a higher or lower gain state based on the selected hysteresis (e.g., power level hysteresis or temporal hysteresis).

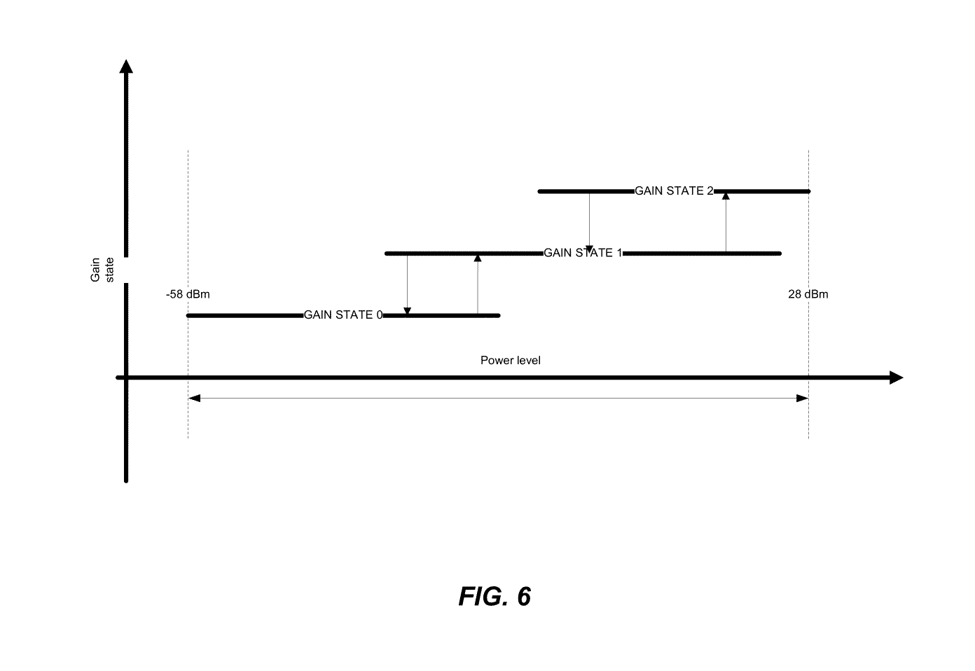

In the present configuration, when the UE determines to use power level hysteresis the UE will move to a higher gain state when there is an overlap in gain states. FIG. 6 illustrates a chart for power level hysteresis. As shown in FIG. 6, gain state zero overlaps with gain state one, and gain state one overlaps with gain state two. It should be noted that FIG. 6 is not drawn to scale and is a non-limiting example of the range of gain states.

Based on an aspect of the present disclosure, when the UE determines to use a power level hysteresis, the UE transitions from a low gain state to a high gain state, such as gain state zero to gain state one, when the power level is in the overlap of gain state zero and gain state one. Furthermore, as shown in FIG. 6, when the UE determines to use a power level hysteresis, the UE may transition from gain state one to gain state two when the power level is in the overlap of gain state one and gain state two. The transition from a low to high gain state occurs based on a timing of the overlap or at specific power levels. Furthermore, for power level hysteresis, the gain state may transition from a high gain state to a low gain state, such as from gain state one to gain state zero. Accordingly, the transition from a high to low gain state occurs based on a timing of the overlap or at specific power levels.

Adjusting the gain state based on the overlap may mitigate a constant adjustment of the gain state. The adjustment of the gain state may create distortion, and therefore, adjusting the gain state may mitigate distortion.

As discussed above, aspects of the present disclosure provide for determining whether to use a power level hysteresis or temporal hysteresis. The determination may be made prior to or during voice or data communications. Furthermore, based on the determined hysteresis mode, the UE may move to a higher gain state or lower gain state when in an overlap gain state.

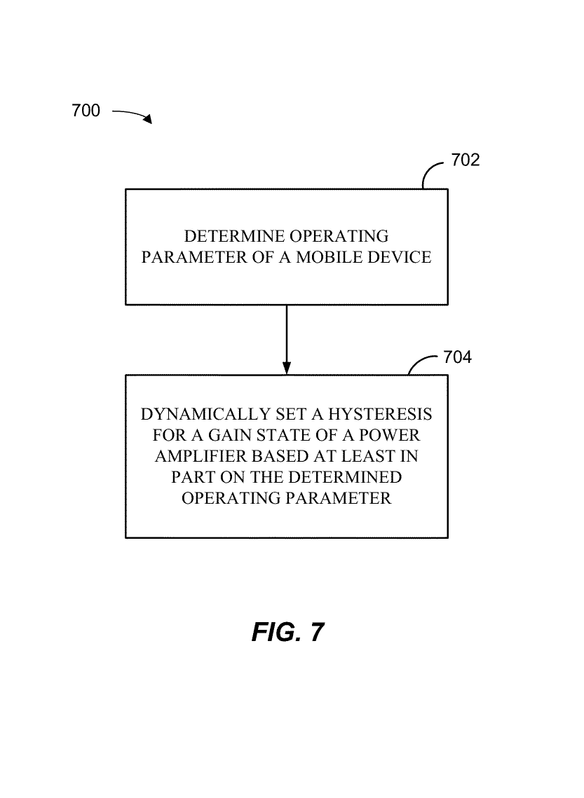

FIG. 7 shows a wireless communication method 700 according to one aspect of the disclosure. As shown at block 702, a mobile device may determine an operating parameter. Furthermore, at block 704, the mobile device may dynamically set a hysteresis for a gain state of a power amplifier (PA) based at least in part on the determined operating parameter.

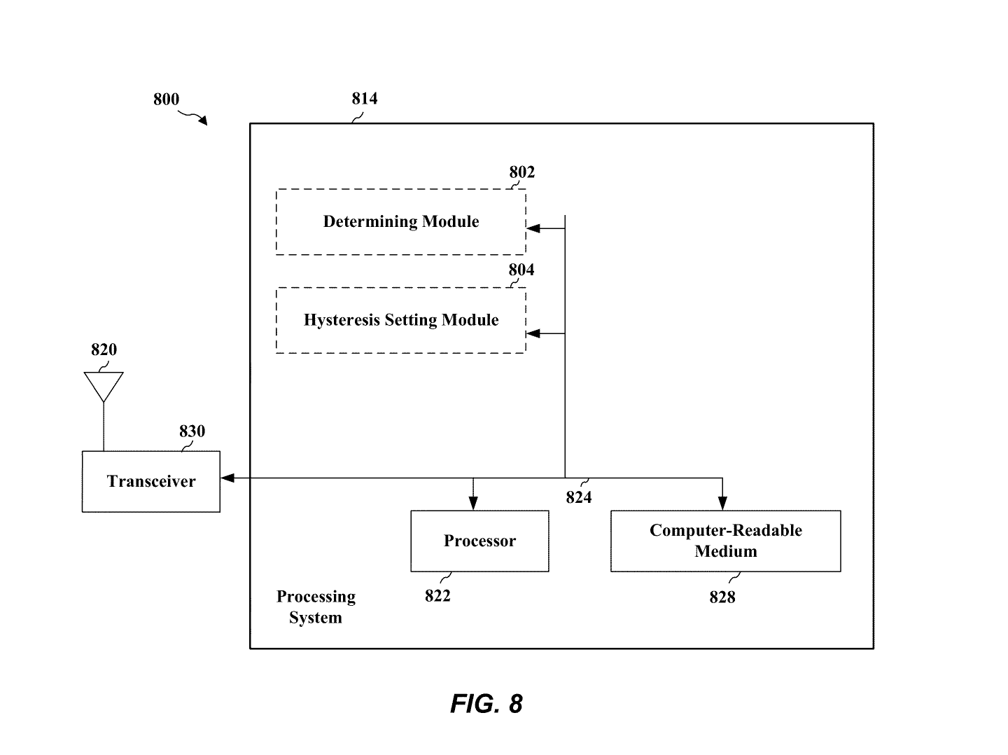

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822 the modules 802, 804, and the computer-readable medium 828. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a computer-readable medium 828. The processor 822 is responsible for general processing, including the execution of software stored on the computer-readable medium 828. The software, when executed by the processor 822, causes the processing system 814 to perform the various functions described for any particular apparatus. The computer-readable medium 828 may also be used for storing data that is manipulated by the processor 822 when executing software.

The processing system 814 includes a determining module 802 for determining an operating parameter of the mobile device. The processing system 814 also includes a hysteresis setting module 804 for dynamically setting a hysteresis for a gain state of a power amplifier based at least in part on the determined operating parameter. The modules may be software modules running in the processor 822, resident/stored in the computer-readable medium 828, one or more hardware modules coupled to the processor 822, or some combination thereof The processing system 814 may be a component of the UE 350 and may include the memory 392, and/or the controller/processor 390.

In one configuration, an apparatus such as a UE is configured for wireless communication including means for determining and means for setting. In one aspect, the above means may be the antennas 352, the receiver 354, the channel processor 394, the receive frame processor 360, the receive processor 380, the transmitter 356, the transmit frame processor 382, the transmit processor 380, the controller/processor 390, the memory 392, hysteresis module 391, determining module 802, hysteresis setting module 804 and/or the processing system 814 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining an operating parameter of a mobile device; and
dynamically setting a hysteresis for a gain state of a power amplifier (PA) based at least in part on the determined operating parameter.

2. The method of claim 1, in which the operating parameter is a time slot assignment.

3. The method of claim 1, in which the operating parameter is a wireless network of the mobile device.

4. The method of claim 1, in which the operating parameter is based at least in part on network feedback.

5. The method of claim 4, in which the network feedback comprises transmit power control commands and/or acknowledgement/negative acknowledgement (ACK/NAK) messages.

6. The method of claim 1, the hysteresis comprising a power level hysteresis and a temporal hysteresis.

7. An apparatus for wireless communications, comprising:
means for determining an operating parameter of a mobile device; and
means for dynamically setting a hysteresis for a gain state of a power amplifier (PA) based at least in part on the determined operating parameter.

8. The apparatus of claim 7, in which the operating parameter is a time slot assignment.

9. The apparatus of claim 7, in which the operating parameter is a wireless network of the mobile device.

10. The apparatus of claim 7, in which the operating parameter is based at least in part on network feedback.

11. A computer program product for wireless communications, the computer program product comprising:
a non-transitory computer-readable medium having program code recorded thereon, the program code comprising:
program code to determine an operating parameter of a mobile device; and
program code to dynamically setting a hysteresis for a gain state of a power amplifier (PA) based at least in part on the determined operating parameter.

12. The computer program product of claim 11, in which the operating parameter is a time slot assignment.

13. The computer program product of claim 11, in which the operating parameter is a wireless network of the mobile device.

14. The computer program product of claim 11, in which the operating parameter is based at least in part on network feedback.

15. An apparatus for wireless communications, comprising:
a memory; and
at least one processor coupled to the memory, the at least one processor being configured:
to determine an operating parameter of a mobile device; and
to dynamically setting a hysteresis for a gain state of a power amplifier (PA) based at least in part on the determined operating parameter.

16. The apparatus of claim 15, in which the operating parameter is a time slot assignment.

17. The apparatus of claim 15, in which the operating parameter is a wireless network of the mobile device.

18. The apparatus of claim 15, in which the operating parameter is based at least in part on network feedback.

19. The apparatus of claim 18, in which the network feedback comprises transmit power control commands and/or acknowledgement/negative acknowledgement (ACK/NAK) messages.

20. The apparatus of claim 15, the hysteresis comprising a power level hysteresis and a temporal hysteresis.
